(19) United States
(12) Patent Application Publication
(10) Pub. No.: US 2017/0238295 A1
(43) Pub. Date: Aug. 17, 2017

(54) COMMUNICATION CONTROL DEVICE, COMMUNICATION CONTROL METHOD, AND NON-TRANSITORY COMPUTER-READABLE STORAGE MEDIUM

(71) Applicant: FUJITSU LIMITED, Kawasaki-shi (JP)

(72) Inventor: Hiroaki SENOO, Kawasaki (JP)

(21) Appl. No.: 15/432,763

(22) Filed: Feb. 14, 2017

(30) Foreign Application Priority Data
Feb. 17, 2016 (JP) 2016-027798

(51) Int. Cl. H04W 72/04; H04W 24/02; H04L 5/00

(52) U.S. Cl. CPC H04W 72/0406; H04L 5/0007; H04W 24/02

(57) ABSTRACT

A communication control device including a memory and a processor coupled to the memory and the processor configured to select a radio access technology among from a first radio access technology and second radio access technology based on utilization efficiency, a first load factor and a second load factor, the utilization efficiency depending on a packet length of a packet used in communication between a terminal device and a first wireless communication device by using a first radio access technology or between the terminal device and a second wireless communication device by using a second radio access technology, the first load factor indicating a load of radio resources corresponding to the first radio access technology, the second load factor indicating a load of radio resources corresponding to the second radio access technology, and cause the terminal device to execute communication by using the selected radio access technology.

### CROSS-REFERENCE TO RELATED APPLICATION

This application is based upon and claims the benefit of priority of the prior Japanese Patent Application No. 2016-027798, filed on Feb. 17, 2016, the entire contents of which are incorporated herein by reference.

### FIELD

The embodiments discussed herein are related to a communication control device, a communication control method, and a non-transitory computer-readable storage medium.

### BACKGROUND

A radio access technology such as wireless local area network (LAN) (hereinafter, may be referred to as “WLAN”) can be being currently used in addition to a radio access technology such as Long-Term Evolution (LTE) in a place where many users who use terminal devices gather. In such a case, the user (or terminal device) can preferentially use, for example, WLAN. Accordingly, for example, it is possible to reduce a load of a system that uses the radio access technology such as LTE. LTE is a radio access technology that has been examined by the 3rd generation partnership project (3GPP). For example, a cooperation method of LTE and WLAN has also been examined in the 3GPP.

Meanwhile, for example, WLAN is a radio access technology of which the specification has been examined by the Institute of Electrical and Electronic Engineers (IEEE), and has been standardized as 802.11 series (IEEE 802.11a or IEEE 802.11ac). For example, in WLAN, carrier sense multiple access/collision avoidance (CSM/CA) has been adopted as a communication protocol of a data link layer. For example, CSMA/CA is a communication protocol acquired by combining carrier sensing with a collision avoidance procedure. In CSMA/CA, the respective terminals transmit data after a waiting time having a random time length elapses.

In both the case of WLAN and the case of LTE, time utilization efficiency of first traffic of which a packet length is less than a threshold is further decreased than time utilization efficiency of second traffic of which a packet length is greater than the threshold. For example, this is because the number of packets in the first traffic is greater than that in the second traffic at a certain time unit and the number of headers is accordingly increased, so that the amount of data becomes less. For example, the time utilization efficiency is the amount of data capable of being transmitted in a certain time unit.

However, the time utilization efficiency of the first traffic in the case of WLAN is further decreased than that in the case of LTE, and thus, time utilization efficiency depending on a packet length in WLAN is further changed than that in LTE. For example, since CSMA/CA is adopted and a waiting time having a random time length exists in a transmission time of data, an overhead is larger due to the waiting time in WLAN than that in LTE. That is, such a larger overhead is one cause of the above-described decrease and change in WLAN.

An example of a technology related to such wireless communication is as follows. That is, there is a base station apparatus that conducts a handover of a small packet of which a packet length Lpn is not equal to or greater than a threshold Lth0 from wireless LAN to LTE. According to this technology, it is expected that congestion occurring in a network between the base station apparatus and an IP service network can be reduced.

There is a wireless terminal or a base station that performs switching to another wireless system depending on whether or not degrees of congestion in all resources indicating actual communication amounts with respect to allowable communication amounts of all resources are equal to or greater than a predetermined threshold. According to this technology, it is expected that switching to a wireless system can be performed without wastefully securing resources to be periodically secured for the wireless system that simultaneously use different kinds of resources.

There is a communication device that selects a path used in data transmission by a single-path selection method of selecting a signal path or a multiple-path selection method of simultaneously selecting multiple paths based on information of an effective rate of each path by estimating an effective rate from combinations of a PHY rate and a received power, and a PHY rate and statistical information. According to this technology, it is expected that any one path or a plurality of paths is selected from multiple paths present between the communication device and another communication device and thus, communication can be suitably performed through the selected path.

Examples of related art include International Publication Pamphlet No. WO 2014/207895, and Japanese Laid-open Patent Publication Nos. 2010-171520 and 2013-26947.

Examples of related art include 3GPP TS 23.234 V12.0.0 (2014-09) “3GPP system to Wireless Local Area Network (WLAN) interworking System description (Release 12)”, and “Study on Throughput Performance of IEEE 802.11 and LTE networks in Multiple-terminal Environment”, IEICT Tech, Rep, vol. 112, no. 44, MoMuC, pp. 129-134, May 14, 2012.

### SUMMARY

According to an aspect of the invention, a communication control device including a memory and a processor coupled to the memory and the processor configured to select a radio access technology among from a first radio access technology and second radio access technology based on utilization efficiency, a first load factor and a second load factor, the utilization efficiency depending on a packet length of a packet used in communication between a terminal device and a first wireless communication device by using a first radio access technology or between the terminal device and a second wireless communication device by using a second radio access technology, the terminal device being capable of communicating with both the first wireless communication device and the second wireless communication device, the first load factor indicating a load of radio resources corresponding to the first radio access technology, the second load factor indicating a load of radio resources corresponding to the second radio access technology, and cause the terminal device to execute communication by using the selected radio access technology.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a structure example of a wireless communication system;

FIG. 2 is a diagram illustrating a structure example of the wireless communication system;

FIG. 3 is a structure example of a base station apparatus or a WLAN access point;

FIG. 4 is a diagram illustrating a structure example of a terminal device;

FIG. 5 is a diagram illustrating a structure example of S-GW, P-GW, or GW;

FIG. 6 is a diagram illustrating a structure example of a communication control device;

FIG. 7A is a diagram illustrating a measurement example of an LTE load factor;

FIG. 7B is a diagram illustrating a measurement example of a WLAN load factor;

FIG. 8 is a sequence diagram illustrating an operation example;

FIG. 9 is a flowchart illustrating an operation example of a radio access technology selection process;

FIG. 10 is a flowchart illustrating an operation example of a WLAN utilization efficiency calculation process;

FIG. 11A is a diagram illustrating an example of WLAN feature information;

FIG. 11B is a diagram illustrating an example of radio quality conversion information;

FIG. 12A is a diagram illustrating an example of CMS;

FIG. 12B is a diagram illustrating an example of WLAN utilization efficiency;

FIG. 13 is a diagram illustrating an example of WLAN utilization efficiency;

FIG. 14 is a graph illustrating a relationship example between the number of users and system capacity;

FIG. 15 is a diagram illustrating a structure example of the communication control device;

FIG. 16 is a diagram illustrating a structure example of the terminal device; and

FIG. 17 is a sequence diagram illustrating the operation example.

### DESCRIPTION OF EMBODIMENTS

As described above, time utilization efficiency depending on a packet length in WLAN is further changed than that in the case of LTE. Accordingly, in a technology for conducting a handover of a small packet of which a packet length Lpn is not equal to or greater than a threshold Lth0 from LTE to WLAN, since the small packet is transmitted to WLAN, the time utilization efficiency is further decreased than that in a case where the small packet is transmitted to LTE.

Neither a technology for switching to another wireless system depending on whether or not degrees of congestion in all resources are equal to or greater than a predetermined threshold nor a technology for selecting a single-path selection method or a multiple-path selection method based on information of an effective rate of each path takes the time utilization efficiency depending on the packet length into consideration. Accordingly, in these technologies, the time utilization efficiency may be decreased in another wireless communication system as a switching destination or a selected path.

Thus, an object of one aspect is to improve time utilization efficiency of a radio access technology in which the time utilization efficiency is changed depending on a packet length so as to be equal to or greater than a threshold.

Hereinafter, embodiments for implementing the present disclosure will be described. The following embodiments are not intended to limit the disclosed technology. The respective embodiments may be appropriately combined without causing contradiction of processing content.

As terms used in the present specification or technical content described in the present specification, terms or technical contents described in specifications as a standard related to communication in the 3GPP or the IEEE may be appropriately used. As an example of such specifications, there is 3GPP TS 23.234 V12.0.0 (2014-09) “3GPP system to Wireless Local Area Network (WLAN) interworking system description (Release 12)”.

### First Embodiment

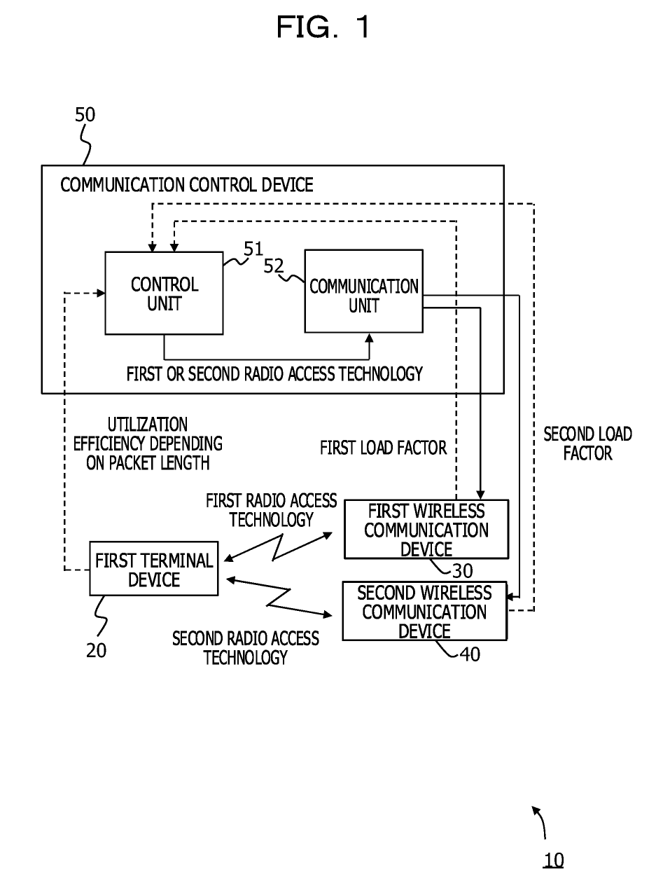

A first embodiment will be described. FIG. 1 is a diagram illustrating a structure example of a wireless communication system 10 according to the first embodiment.

The wireless communication system 10 includes a first terminal device 20, first and second wireless communication devices 30 and 40, and a communication control device 50.

The first terminal device 20 may perform wireless communication by using a first or second radio access technology. For example, the first terminal device 20 includes a feature phone, a smart phone, a tablet terminal, a personal computer, and a game device.

The first wireless communication device 30 performs wireless communication by using a first radio access technology. For example, the first radio access technology includes a wireless LAN of IEEE 802.11a. The second wireless communication device 40 performs wireless communication by using a second radio access technology. For example, the second radio access technology includes LTE in the 3GPP. The first and second wireless communication devices 30 and 40 performs wireless communication with the first terminal device 20 in communication available ranges of these devices, and can provide various service such as phone call services or web browsing services.

The communication control device 50 includes a control unit 51 and a communication unit 52.

The control unit 51 selects the first or second radio access technology based on utilization efficiency depending on a packet length of a packet used in transmission or reception in the first terminal device 20, a first load factor in the first wireless communication device 30, and a second load factor in the second wireless communication device 40. For example, the first load factor represents a load rate of radio resources in the first wireless communication device 30 that performs wireless communication by using the first radio access technology. For example, the second load factor represents a load rate of radio resources in the second wireless communication device 40 that performs wireless communication by using the second radio access technology.

The communication unit 52 transmits the selected first or second radio access technology to the first terminal device 20 via the first or second wireless communication devices 30 and 40.

For example, the utilization efficiency depending on the packet length corresponds to the time utilization efficiency, and the time utilization efficiency is equal to or greater than a time utilization efficiency threshold when the packet length is equal to or greater than a packet length threshold and the time utilization efficiency is less than the time utilization efficiency threshold when the packet length is less than the packet length threshold. For example, the time utilization efficiency represents the amount of data (or the number of bits) capable of being transmitted within a certain time, and may be referred to as a throughput or system capacity.

For example, the first radio access technology is a radio access technology in which the time utilization efficiency depending on the packet length is further changed than that in the second radio access technology. For example, when the packet length is equal or greater than the packet length threshold, two radio access technologies are almost not changed. However, the time utilization efficiency when the packet length is less than the packet length threshold in the first radio access technology is further decreased than that in the second radio access technology.

For example, a case where the utilization efficiency depending on the packet length is equal to or less than the utilization efficiency threshold when the first terminal device 20 performs the wireless communication by using the first radio access technology is considered. In this case, the first terminal device 20 performs wireless communication by using a packet of which a packet length is less than the packet length threshold. If such a first terminal device 20 uses the first radio access technology, the time utilization efficiency in the first terminal device 20 is decreased, and the time utilization efficiency is also decreased in the first wireless communication device 30 due to the use of the first radio access technology by the first terminal device 20.

In such a case, the control unit 51 changes the radio access technology of the first terminal device 20 from the first radio access technology to the second radio access technology. Accordingly, for example, the time utilization efficiency of the first terminal device 20 itself is improved further than that in a case where the first radio access technology is used, and since the first wireless communication device 30 is not connected to the first terminal device 20, it is possible to improve the time utilization efficiency.

Thus, the communication control device 50 can improve the time utilization efficiency of the radio access technology in which the time utilization efficiency is changed depending on the packet length so as to be equal to or greater than the threshold.

In the first embodiment, the control unit 51 selects the radio access technology in consideration of the first and second load factors. Accordingly, it is possible to select the radio access technology in which a load of the first or second wireless communication device 30 or 40 is reduced by taking the loads of the first and second wireless communication devices 30 and 40 into consideration. Therefore, in the first embodiment, it is possible to reduce the load of the entire wireless communication system 10.

For example, the control unit 51 may calculate the utilization efficiency depending on the packet length based on radio quality information in a radio section between the first or second wireless communication device 30 or 40 that performs the wireless communication with the first terminal device 20 and the first terminal device 20.

### Second Embodiment

Hereinafter, a second embodiment will be described.

<Structure Example of Wireless Communication System>

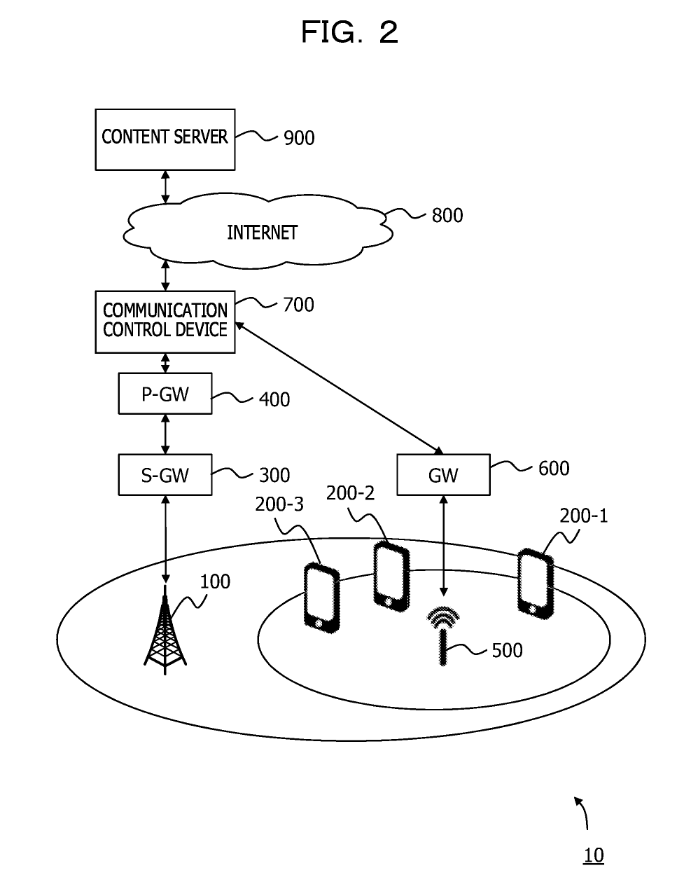

FIG. 2 is a diagram illustrating a structure example of the wireless communication system 10 according to the second embodiment. The wireless communication system 10 includes a radio base station apparatus (or Evolved Node B (eNB)) (hereinafter, may be referred to as a “base station”) 100, wireless terminal devices (or user equipment (UE)) (hereinafter, may be respectively referred to as a “terminal”) 200-1 to 200-3, a serving gateway (S-GW) 300, and a packet data network gateway (P-GW) 400. The wireless communication system 10 includes a wireless LAN access point (hereinafter, may be referred to as a “WLAN access point”), a gateway (GW) 600, a communication control device 700, the Internet 800, and a content server 900.

For example, the first terminal device 20, the first wireless communication device 30, and the second wireless communication device 40 which are described in the first embodiment correspond to the terminals 200-1 to 200-3, the base station 100, and the WLAN access point 500, respectively.

As illustrated in FIG. 2, the wireless communication system 10 includes an LTE system constituted by the base station 100, the S-GW 300, and the P-GW 400. The wireless communication system 10 includes a WLAN system constituted by the WLAN access point 500 and the GW 600. As stated above, the wireless communication system 10 includes a wireless communication system using two radio access technologies. For example, the LTE system and the WLAN system may be referred to a cellular wireless communication system and a non-cellular wireless communication system, respectively. For example, in addition to the LTE system, a system of which the specification is achieved by the 3GPP and a system such as LTE-Advanced, 3G, or 5G of which the examination is currently being started may be applied to the LTE system. For example, a radio access technology such as IEEE 802.11a or IEEE 802.11ac of which the specification is achieved by the IEEE may be applied to the WLAN system.

The base station 100 is a wireless communication device capable of performing wireless communication with the terminals 200-1 to 200-3 located in communication available range of the base station. For example, such a communication available range may be referred to as a cell. For example, the cell may be provided for each antenna provided in the base station 100, and may be a network object capable of being recognized by the terminals 200-1 to 200-3. For example, the base station 100 performs wireless communication with the terminals 200-1 to 200-3 by using a radio access technology through LTE.

For example, the terminals 200-1 to 200-3 are wireless communication devices such as a feature phone, a smart phone, a tablet terminal, a personal computer, and a game device. Various services such as phone call service or web services may be offered to the terminals 200-1 to 200-3 via the base station 100 or the WLAN access point 500.

The terminals 200-1 to 200-3 may use two radio access technologies of LTE and WLAN, and may perform wireless communication by using any radio access technology. In the example of FIG. 2, the terminals 200-1 and 200-2 perform wireless communication by using a radio access technology through WLAN, and the terminal 200-3 performs wireless communication by using a radio access technology through LTE. Accordingly, the terminals 200-1 and 200-2 are connected to the WLAN access point 500, and the terminal 200-3 is connected to the base station 100. Hereinafter, the terminals 200-1 to 200-3 have the same structure, and thus, these terminals may be referred to as the terminal 200 unless otherwise stated.

For example, the S-GW 300 is a gateway that relays data between the base station 100 and the P-GW 400.

For example, the P-GW 400 is a gateway that connects the wireless communication system 10 and the Internet 800 and relays data between the Internet 800 and the wireless communication system 10.

The WLAN access point 500 is a wireless communication device capable of performing wireless communication with the terminal 200 located in the communication available range of the WLAN access point. For example, the WLAN access point 500 may perform wireless communication by using the radio access technology through WLAN, such as IEEE 802.11 series, of which the specification is achieved by the IEEE.

One WLAN access point 500 corresponds to one cell. For example, the WLAN access point 500 itself may be one cell.

For example, the GW 600 is a gateway that relays data between the WLAN access point 500 and the communication control device 700. A plurality of WLAN access points may be connected to the GW 600.

For example, the communication control device 700 selects (or changes) the radio access technology of the terminal 200 based on the time efficiency depending on the packet length and a load state of the cell. The communication control device 700 transmits the selected radio access technology to the terminal 200.

The communication control device 700 relays packet data between the P-GW 400 and the content server 900 and between the GW 500 and the content server 900. For example, as the type of the packet data, there is an Internet Protocol (IP) packet. Hereinafter, the packet data may be used without being distinguished between the packet data and the packet.

The content server 900 is connected to the communication control device 700 via the Internet 800. The content server 900 stores content data such as image or sound, and delivers the content data to the terminal 200 according to a request from the terminal 200. The content server 900 includes a large-capacity storage medium such as a hard disk drive (HDD), and stores the content data in the large-capacity storage medium.

Hereinafter, the details of the respective devices 100, 200, 300, 400, 500, 600, and 700 will be described.

<Structure Example of Base Station 100>

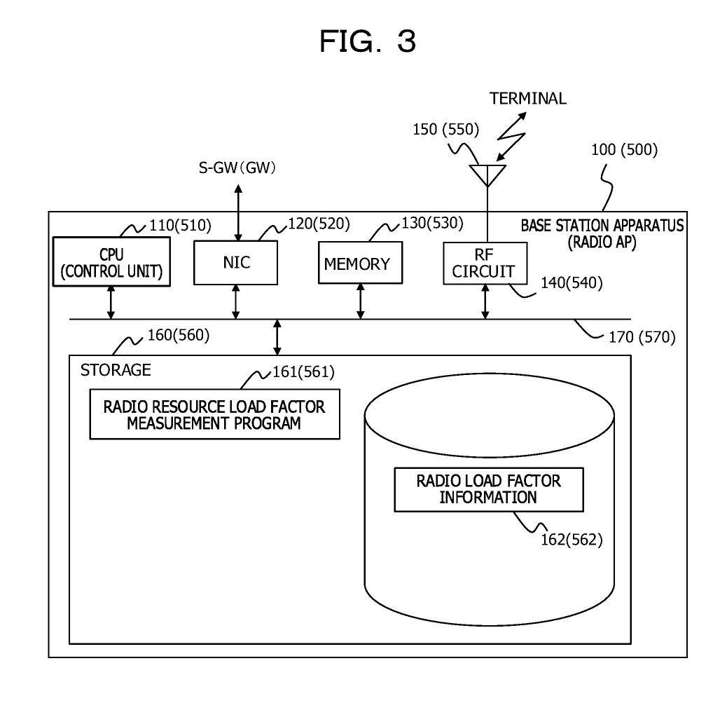

FIG. 3 is a structure example of the base station 100. The base station 100 includes a central processing unit (CPU) (or control unit) 110, a network interface card (NIC) 120, a memory 130, a radio frequency (RF) circuit 140, an antenna 150, and a storage 160. The CPU 110, the NIC 120, the memory 130, the RF circuit 140, and the storage 160 are connected to one another via an internal bus 170.

For example, the CPU 110 performs a process related to the wireless communication using LTE. For example, the CPU 110 performs the following process. That is, the CPU 110 performs scheduling to allocate radio resources to each user (or each terminal 200), or determines a coding rate or a modulation scheme. The CPU 110 performs an error correction coding process (hereinafter, may be referred to as “coding process”) and a modulation process on data according to the scheduling result to convert the data into a baseband signal, and outputs the converted baseband signal to the RF circuit 140. The CPU 110 may generate a control signal indicating the scheduling result, may perform the modulation process on the control signal to convert the control signal into the baseband signal, and may output the baseband signal to the RF circuit 140. The CPU 110 receives the baseband signal output from the RF circuit 140, and performs a demodulation process or an error correction decoding process (hereinafter, may be referred to as a “decoding process”) on the baseband signal according to the scheduling result to extract the data. For example, the CPU 110 may the above-described process by reading a wireless communication program for LTE stored in the storage 160 and executing the read program.

The CPU 110 measures a radio resource load factor (or radio resource utilization rate) (hereinafter, may be referred to as an “LTE load factor”) for each cell in LTE by reading a radio resource load factor measurement program 161 stored in the storage 160 and executing the program.

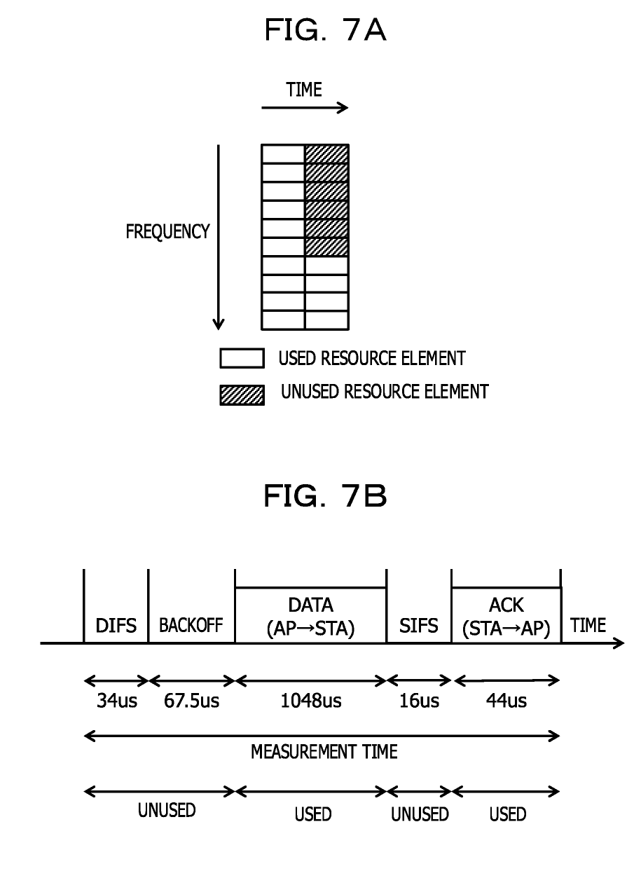

FIG. 7A is a diagram illustrating a measurement example of the LTE load factor. For example, the CPU 110 calculates the LTE load factor by using LTE load factor=(number of resource elements in use/number of all resource elements capable of being used)×100 [%] . . . (1). In the example of FIG. 7A, LTE load factor=(14/20)×100=70%. For example, the LTE load factor represents a load (or utilization) rate of radio resources used in the wireless communication through LTE in the base station 100.

For example, Expression (1) is stored in the storage 160, and is appropriately read and executed from the storage 160 when the radio resource load factor measurement program 161 is executed by the CPU 110. The CPU 110 outputs the measured LTE load factor to the NIC 120, and transmits the LTE load factor to the communication control device 700.

The NIC 120 exchanges the packet with the S-GW 300. The NIC 120 receives the packet transmitted from the S-GW 300, extracts the data from the packet, and outputs the extracted data to the CPU 110 or the memory 130, according to an instruction from the CPU 110. The NIC 120 converts the data received from the CPU 110 into the packet, and transmits the converted packet to the S-GW 300, according to the instruction from the CPU 110.

For example, the memory 130 appropriately stores values when the CPU 110 executes various programs. The memory 130 may function as a working memory of the CPU 110.

The RF circuit 140 performs a frequency conversion process or an amplification process on the baseband signal output from the CPU 110 to convert the baseband signal into a radio signal (performs up-conversion), and outputs the radio signal to the antenna 150. The RF circuit 140 receives the radio signal output from the antenna 150, performs the amplification process or the frequency conversion process on the received radio signal to convert the radio signal into the baseband signal (or performs down-conversion), and outputs the baseband signal to the CPU 110. For example, the RF circuit 140 performs the frequency conversion process by using a frequency used in LTE according to the instruction from the CPU 110.

The antenna 150 transmits the radio signal output from the RF circuit 140 to the terminal 200. The antenna 150 receives the radio signal transmitted from the terminal 200, and outputs the received radio signal to the RF circuit 140.

The storage 160 stores the radio resource load factor measurement program 161 and radio load factor information 162. As mentioned above, the storage 160 may store another program such as the wireless communication program.

<Structure Example of Terminal 200>

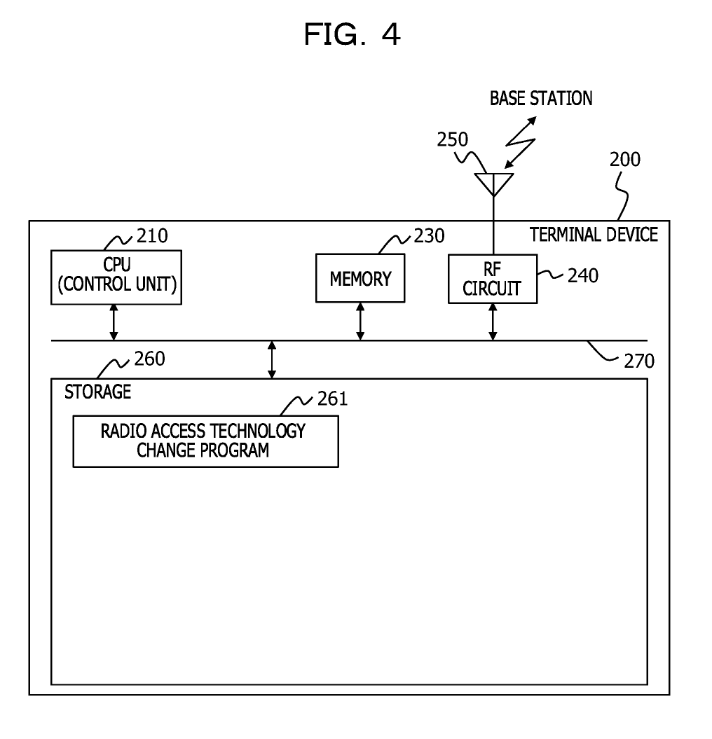

FIG. 4 is a diagram illustrating a structure example of the terminal 200. The terminal 200 includes a CPU (or control unit) 210, a memory 230, an RF circuit 240, an antenna 250, and a storage 260. The CPU 210, the memory 230, the RF circuit 240, and the storage 260 are connected to one another via an internal bus 270.

For example, the CPU 210 performs a process related to the wireless communication using LTE. For example, the CPU 210 performs the following process. That is, the CPU 210 performs the coding process or the modulation process on the data read from the storage 260 to convert the data into the baseband signal, and outputs the baseband signal to the RF circuit 240. The CPU 210 performs the demodulation process or the decoding process on the baseband signal received from the RF circuit 240 to extract the data or the control signal, and outputs the extracted data or control signal to the CPU 210. The CPU 210 performs the coding process or the modulation process according to the scheduling result included in the control signal. In the case of LTE, the base station 100 performs the scheduling, and the terminal 200 performs the wireless communication with the base station 100 according to the scheduling result. The CPU 210 may perform the above-described process by reading the wireless communication process program related to LTE from the storage 260 and executing the read program.

For example, the CPU 210 performs a process related to the wireless communication using WLAN. For example, the CPU 210 performs the following process according to a communication protocol of CSMA/CA. That is, the CPU 210 performs carrier sensing using Distributed Access Interframe Space (DIFS) duration. Subsequently, in order to avoid the collision of frames, the CPU 210 performs the coding process or the modulation process on the data to convert the data into the baseband signal after a random waiting time elapses, and outputs the baseband signal to the RF circuit 240, similarly to the case of LTE. Alternatively, after the random waiting time elapses, the CPU 210 receives the baseband signal from the RF circuit 240, and performs the demodulation process or the decoding process on the baseband signal, similarly to the case of LTE. Thereafter, after Short Interframe Space (SIFS) duration elapses, the CPU 210 receives a response check signal such as ACK from the RF circuit 240 and performs the demodulation process or the decoding process, or generates a response check signal and performs the coding process or the modulation process on the response check signal. For example, in the case of WLAN, the scheduling may not be performed, the coding rate or the modulation scheme may be previously stored in the storage 260, and the CPU 210 may perform the process using these information items. The CPU 210 may perform the above-described process by reading a wireless communication process program related to WLAN from the storage 260 and executing the read program.

The CPU 210 changes the radio access technology by reading a radio access technology change program 261 stored in the storage 260 from the storage 260 and executing the read program. For example, the CPU 210 changes the radio access technology from LTE to WLAN, or changes from WLAN to LTE. Thereafter, the CPU 210 performs the above-described wireless communication by the changed radio access technology.

The CPU 210 measures radio quality between the base station 100 and the terminal 200. For example, the CPU 210 may measure the radio quality by measuring a reception signal level or signal to interference noise ratio (SINR) of the received signal in the RF circuit 240. For example, the CPU 210 may convert the measured radio quality into a modulation and coding scheme (MCS) level, and may transmit the MCS level as the radio quality to the base station 100.

For example, the memory 230 appropriately stores values when the CPU 210 executes various programs. The memory 230 may function as a working memory of the CPU 210.

The RF circuit 240 performs the frequency conversion process or the amplification process on the baseband signal output from the CPU 210 to convert the baseband signal to the radio signal (or performs up-conversion), and outputs the converted radio signal to the antenna 250. The RF circuit 240 receives the radio signal output from the antenna 250, performs the amplification process or the frequency conversion process on the received radio signal to convert the radio signal into the baseband signal (or performs down-conversion), and outputs the converted baseband signal to the CPU 210. The RF circuit 240 may perform the frequency conversion process by using a frequency capable of being used in LTE in the case of LTE and by using a frequency capable of being used in WLAN in the case of WLAN according to the instruction of the CPU 210.

The antenna 250 transmits the radio signal output from the RF circuit 240 to the base station 100. The antenna 250 receives the radio signal transmitted from the base station 100, and outputs the received radio signal to the RF circuit 240.

The storage 260 stores the radio access technology change program 261. The storage 260 may store the wireless communication process program of LTE or WLAN described above. For example, the storage 260 may store a candidate list indicating radio access technologies capable of being used (or selected) by the terminal 200. The CPU 210 may read the list from the storage 260, and may transmit the read list to the base station 100 or the WLAN access point 500.

<Structure Example of S-GW 300 and P-GW 400>

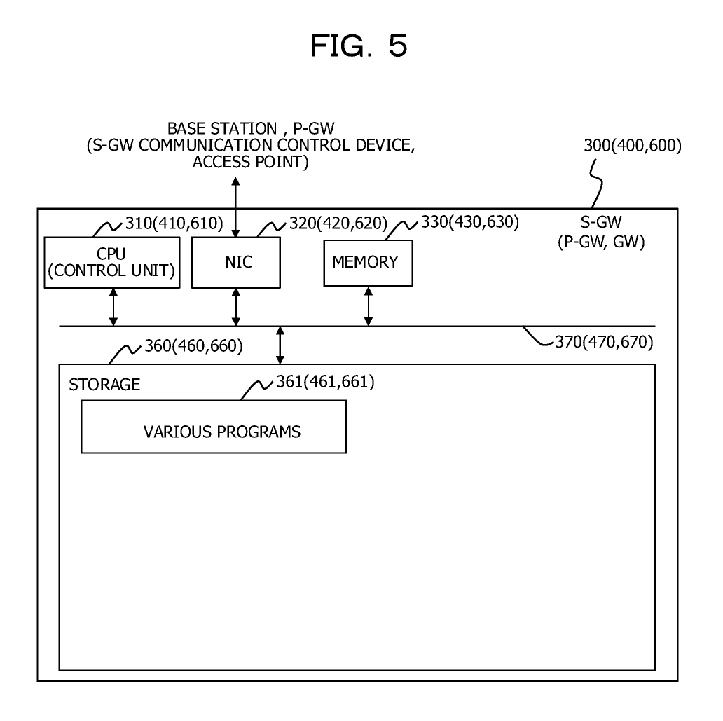

FIG. 5 is a diagram illustrating a structure example of the S-GW 300. The S-GW 300 includes a CPU (or control unit) 310, a NIC 320, a memory 330, and a storage 360. The CPU 310, the NIC 320, the memory 330, and the storage 360 are connected to one another via an internal bus 370.

For example, the CPU 310 performs a relaying process by reading various programs 361 stored in the storage 360 and executing the read program. For example, the CPU 310 instructs the NIC 320 to convert the packet received from the base station 100 to be in a format capable of being transmitted to the P-GW 400 or the packet received from the P-GW 400 to be in a format capable of being transmitted to the base station 100 and to transmit the converted packet to each transmission destination.

The NIC 320 is connected to the base station 100 and the P-GW 400. The NIC 320 performs the format conversion of the packet and transmits the converted packet to the transmission destination according to the instruction of the CPU 310.

The memory 330 appropriately stores values when the CPU 310 executes various programs 361. The memory 330 may function as a working memory of the CPU 310.

The storage 360 stores various programs 361.

FIG. 5 illustrates a structure of the P-GW 400. The P-GW 400 includes a CPU 410, an NIC 420, a memory 430, and a storage 460. The CPU 410, the NIC 420, the memory 430, and the storage 460 are connected to one another via an internal bus 470.

For example, the CPU 410 performs a relaying process by reading various programs 461 stored in the storage 460 and executing the read program. For example, the CPU 410 instructs the NIC 420 to convert the packet received from the S-GW 300 to be in a format capable of being transmitted to the communication control device 700 or the packet received from the communication control device 700 to be in a format capable of being transmitted to the S-GW 300 and transmit the converted packet to the transmission destination. For example, as an example of the format capable of being transmitted to the communication control device 700, there is an IP packet.

The NIC 420 is connected to the S-GW 300 and the communication control device 700. The NIC 420 performs the format conversion of the packet and transmits the converted packet to the transmission destination according to the instruction of the CPU 410.

For example, the memory 430 appropriately stores values when the CPU 410 executes various programs 461. The memory 430 may function as a working memory of the CPU 410.

The storage 460 stores various programs 461.

<Structure Example of WLAN Access Point 500>

FIG. 3 illustrates a structure of the WLAN access point 500. The WLAN access point 500 includes a CPU 510, an NIC 520, a memory 530, an RF circuit 540, an antenna 550, and a storage 560. The CPU 510, the NIC 520, the memory 530, the RF circuit 540, and the storage 560 are connected to one another via an internal bus 570.

For example, the CPU 510 performs a process related to the wireless communication using WLAN. For example, the CPU 510 performs the following process according to a communication protocol of CSMA/CA. That is, the CPU 510 performs carrier sensing by using Distributed Access Interframe Space (DIFS) duration, and converts the coding process or the modulation process on the data to convert the data into the baseband signal and output the baseband signal to the RF circuit 540 after a random waiting time elapses. Alternatively, the CPU 510 receives the baseband signal from the RF circuit 540 after the random waiting time elapses, and performs the demodulation process or the decoding process on the baseband signal. Thereafter, after Short Interframe Space (SIFS) duration elapses, the CPU 510 receives the response check signal such as ACK from the RF circuit 540 and performs the demodulation process or the decoding process, or generates the response check signal and performs the coding process or the modulation process on the response check signal. For example, the coding rate or the modulation scheme may be previously stored in the storage 560, and the CPU 510 may perform the process using the information. The CPU 510 may perform the above-described process by reading a wireless communication process program related to WLAN from the storage 560 and executing the read program.

The CPU 510 measures a radio resource load factor (hereinafter, may be referred to as a “WLAN load factor”) for each cell in WLAN by reading a radio resource load factor measurement program 561 stored in the storage 560 and executing the program 561.

FIG. 7B is a diagram illustrating a measurement example of the WLAN load factor. For example, the CPU 510 measures the WLAN load factor by using WLAN load factor={(time in which received power level exceeds carrier sensing threshold+transmission time of WLAN access point)/measurement time}×100 [%] . . . (2). In the example of FIG. 7B, WLAN load factor={(1048+44)/(34+67.5+1048+16+44)}×100≈90 [%]. For example, the WLAN load factor represents a load (or utilization) rate of radio resources used in the wireless communication through WLAN in the WLAN access point 500.

For example, Expression (2) is stored in the storage 560, and is appropriately read and executed from the storage 560 when the radio resource load factor measurement program 561 is executed by the CPU 510. The CPU 510 transmits the measured WLAN load factor to the communication control device 700 via the NIC 520.

The NIC 520 exchanges data with the GW 600. The NIC 520 receives the packet transmitted from the GW 600, extracts the data from the packet, and outputs the extracted data to the CPU 510 or the memory 530, according to the instruction from the CPU 510. The NIC 520 converts the data received from the CPU 510 into the packet and transmits the converted packet to the GW 600, according to the instruction form the CPU 510.

For example, the memory 530 appropriately stores values when the CPU 510 executes various programs. The memory 530 functions as a working memory of the CPU 510.

The RF circuit 540 performs the frequency conversion process or the amplification process on the baseband signal output from the CPU 510 to convert the baseband signal into the radio signal (or performs up-conversion) according to the instruction from the CPU 510, and outputs the converted radio signal to the antenna 150. The RF circuit 540 receives the radio signal output from the antenna 550, performs the amplification process or the frequency conversion process on the received radio signal to convert the radio signal into the baseband signal (or performs down-conversion), and outputs the converted baseband signal to the CPU 510. For example, the RF circuit 540 performs the frequency conversion process by using the frequency capable of being used in WLAN according to the instruction from the CPU 510.

The antenna 550 transmits the radio signal output from the RF circuit 540 to the terminal 200. The antenna 550 receives the radio signal transmitted from the terminal 200, and outputs the received radio signal to the RF circuit 540.

The storage 560 stores the radio resource load factor measurement program 561 and radio load factor information 562. As stated above, the storage 560 may store another program such as the wireless communication program for WLAN.

<Structure Example of GW 600>

FIG. 5 illustrates a structure of the GW 600. The GW 600 includes a CPU 610, an NIC 620, a memory 630, and a storage 660. The CPU 610, the NIC 620, the memory 630, and the storage 660 are connected to one another via an internal bus 670.

Similarly to the CPU 310 of the S-GW 300, the CPU 610 reads various programs 661, and performs various processes. As an example of such processes, there is a relaying process between the communication control device 700 and the WLAN access point 500. For example, the CPU 610 instructs the NIC 620 to convert the packet received from the WLAN access point 500 to be in a format capable of being transmitted to the communication control device 700 and to transmit the converted packet. The CPU 610 instructs the NIC 620 to converts the packet received from the communication control device 700 to be in a formation capable of being transmitted to the WLAN access point 500 and to transmit the converted packet. For example, as the format capable of being transmitted to the communication control device 700, there is an IP packet.

The NIC 620 is connected to the WLAN access point 500 and the communication control device 700. The NIC 620 performs the conversion of the packet and transmits the converted packet to the transmission destination according to the instruction of the CPU 610.

For example, the memory 630 appropriately stores values when the CPU 610 executes various programs. The memory 630 may function as a working memory of the CPU 610.

The storage 660 stores various programs 661.

<Structure Example of Communication Control Device 700>

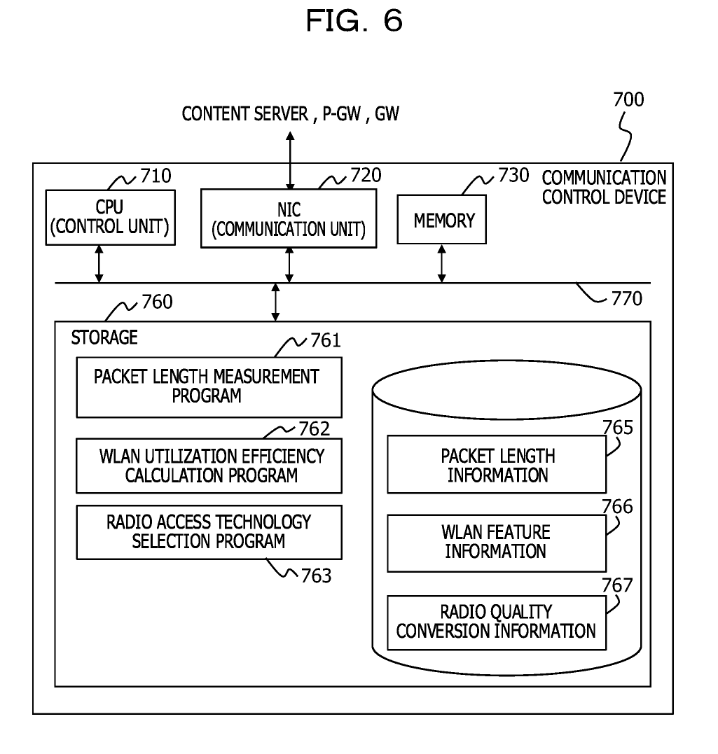

FIG. 6 is a diagram illustrating a structure example of the communication control device 700. The communication control device 700 includes a CPU (or control unit) 710, an NIC (or communication unit) 720, a memory 730, and a storage 760. The CPU 710, the NIC 720, the memory 730, and the storage 760 are connected to one another via an internal bus 770.

For example, the control unit 51 and the communication unit 52 which are described in the first embodiment correspond to the CPU 710 and the NIC 720, respectively.

The CPU 710 measures packet lengths of packets exchanged with the terminal 200 by reading a packet length measurement program 761 stored in the storage 760 and executing the program 761. For example, the CPU 710 measures an average value or a center value of the packet lengths of the packets exchanged with the terminal 200 (or used in the terminal 200) within a predetermined time for each terminal 200. The CPU 710 stores the measured packet length as packet length information 765 in the storage 760.

The CPU 710 calculates WLAN utilization efficiency for each terminal 200 by reading a WLAN utilization efficiency calculation program 762 stored in the storage 760 and executing the program 762. The CPU 710 may store the calculated WLAN utilization efficiency in the storage 760.

For example, the WLAN utilization efficiency represents the number of bits of data capable of being transmitted in an IP layer which is a higher layer than a physical layer (PHY) in an occupancy time occupied for transmitting one frame of the physical layer in WLAN. Alternatively, for example, the WLAN utilization efficiency represents time utilization efficiency depending on the packet length in a case where the terminal 200 uses WLAN irrespective of whether the terminal 200 performs the wireless communication through WLAN or performs the wireless communication through LTE. The details of the WLAN utilization efficiency will be described in an operation example.

For example, the time utilization efficiency is a data amount [bps] of data capable of being transmitted or received in a unit time. For example, the time utilization efficiency may be referred to as throughput or system capacity.

The CPU 710 performs a selection process of the radio access technology on the terminal 200 by reading a radio access technology selection program 763 stored in the storage 760 and executing the program 763. The details of the selection process will be described in the operation example. The CPU 710 transmits the selected radio access technology to the terminal 200 via the NIC 720.

The CPU 710 may read another program stored in the storage 760, and may perform the process. As an example of such a program, there is a relaying process. In this case, for example, the CPU 710 instructs the NIC 720 to transmit the packet received from the content server 900 to the P-GW 400 or to transmit the packet to the GW 600. Whether to transmit the packet to the P-GW 400 or transmit the packet to the GW 600 depends on the result of the selection process of the radio access technology. For example, the CPU 710 instructs the NIC 720 to transmit the packet received from the P-GW 400 or the GW 600 to the content server 900.

The NIC 720 exchanges the packets between the content server 900 and the P-GW 400, and between the content server 900 and the GW 600. For example, as the packet exchanged in the communication control device 700, there is an IP packet. Thus, the NIC 720 may transmit the packet received in the same format as that of the received packet to the transmission destination without particularly performing the conversion of the packet format.

For example, the memory 730 appropriately stores values when the CPU 710 executes various programs. The memory 730 may function as a working memory of the CPU 710.

The storage 760 stores a packet length measurement program 761, a WLAN utilization efficiency calculation program 762, and a radio access technology selection program 763. The storage 760 stores packet length information 765, WLAN feature information 766, and radio quality conversion information 767. The storage 760 may store another program. The details of the WLAN feature information 766 and the radio quality conversion information 767 will be described in the operation example.

<Operation Example>

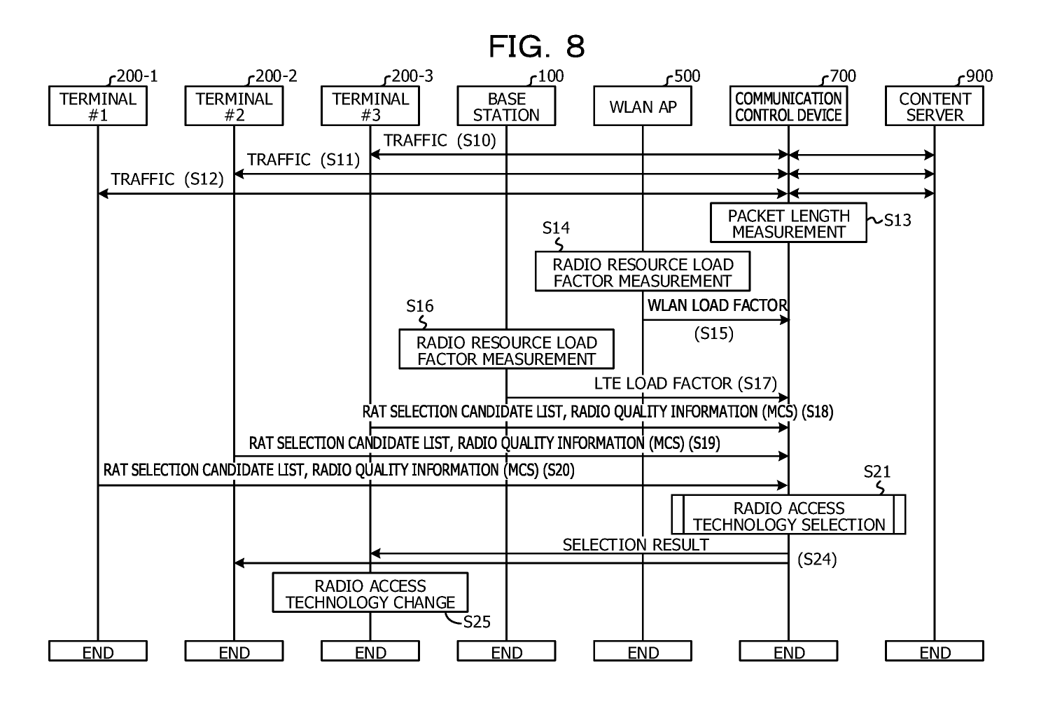

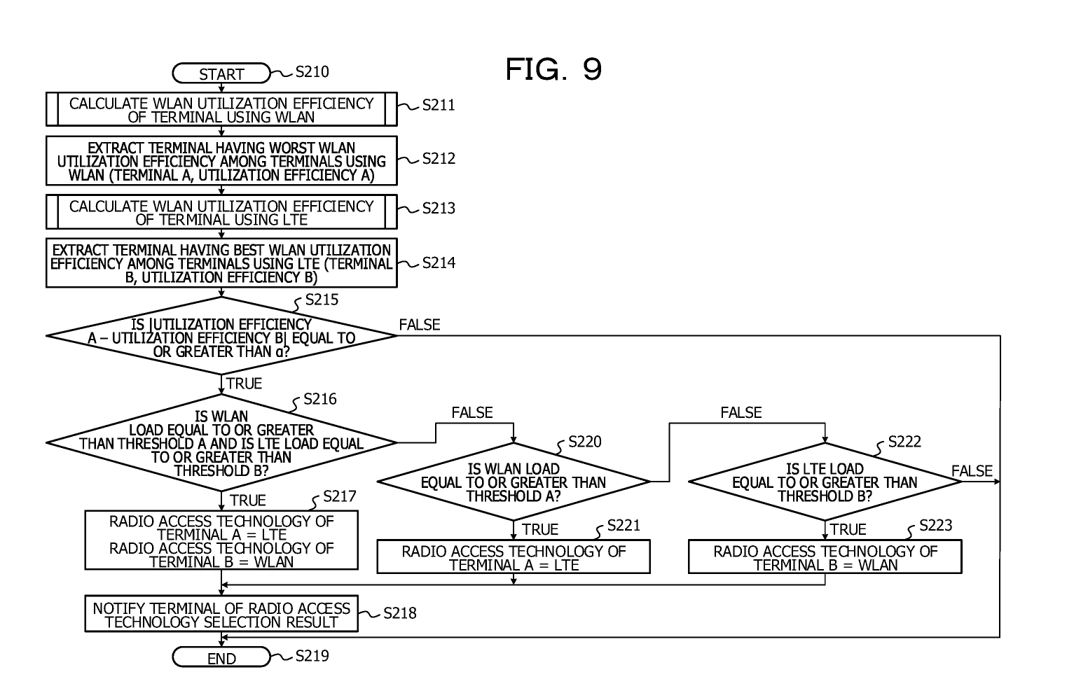

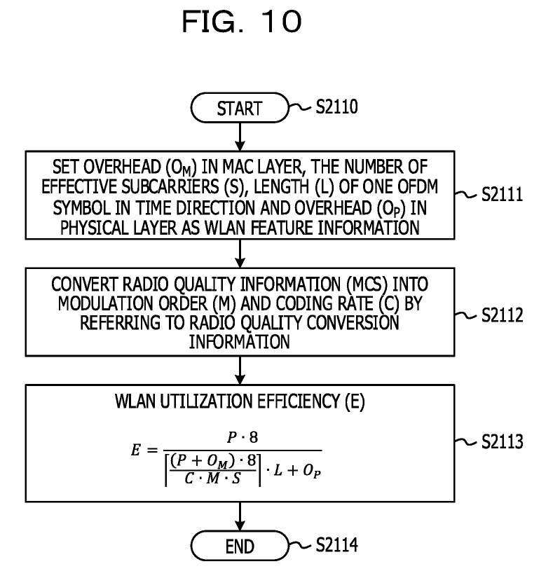

Hereinafter, an operation example will be described. FIG. 8 is a sequence example in the wireless communication system 10, FIG. 9 is a flowchart example of the selection process of the radio access technology, and FIG. 10 is a flowchart example of a WLAN utilization efficiency calculation process.

As illustrated in FIG. 8, the packets are exchanged between the terminals 200-1 to 200-3 and the content server 900, and the packets related to the contents are transmitted from the content server 900 to the terminals 200-1 to 200-3 (S10 to S12).

In this case, the terminals 200-1 to 200-3 perform the wireless communication using any one of the radio access technology through LTE and the radio access technology through WLAN. In the example of FIG. 8, the terminals 200-1 and 200-2 use LTE and the terminal 200-3 uses WLAN. Accordingly, the terminals 200-1 and 200-2 exchange the packets via the base station 100, and the terminal 200-3 exchanges the packet via the WLAN access point (WLAN AP) 500.

Subsequently, the communication control device 700 measures the packet lengths (S13). For example, the CPU 710 executes the packet length measurement program 761, and measures the packet lengths of the packets used in the terminals 200-1 to 200-3 for the terminals 200-1 to 200-3. For example, the IP packet includes a header area having a fixed length and a data area having a variable length. The packet lengths of the individual IP packets are equal to or different from one another depending on the data amount of data transmitted in the data area. For example, the CPU 710 measures the packet lengths (P) of the IP packets received from the NIC 720 one by one for a predetermined time, and measures the average value or center value thereof as the packet length of the IP packet.

Subsequently, the WLAN access point 500 measures the radio resource load factor (or WLAN load factor) (S14), and transmits the measured WLAN load factor to the communication control device 700 (S15). For example, the CPU 510 executes the radio resource load factor measurement program 561, and measures the WLAN load factor by using Expression ( 2). As described above, for example, one WLAN access point 500 corresponds to one cell in WLAN. Thus, for example, the WLAN load factor measured by the WLAN access point 500 represents a load factor (or load amount) of the cell in the radio access technology through WLAN.

Subsequently, the base station 100 measures the radio resource load factor (or LTE load factor)(S16), and transmits the measured LTE load factor to the communication control device 700 (S17). For example, the CPU 110 executes the radio resource load factor measurement program 161, and measures the LTE load factor by using Expression (1). For example, the CPU 110 performs scheduling on each cell through a scheduling process, and thus, the CPU may measure the LTE load factor for each cell through the scheduling process. For example, the LTE load factor measured by the base station 100 represents a load factor (or load amount) of the cell in the radio access technology through LTE.

In FIG. 8, the processing order to execute measurement of WLAN load factor(S14 and S15) and measurement of LTE load factor (S16 and S17) may be replaced.

Subsequently, the terminal 200-1 transmits radio quality information related to radio quality and a candidate list related to radio access technologies (RATs) capable of being selected by the terminal 200-1 to the communication control device 700 (S20). Similarly, the terminals 200-2 and 200-3 transmit the candidate list of the radio access technologies and the radio quality information to the communication control device 700 (S19 and S18).

Subsequently, the communication control device 700 performs the selection process of the radio access technology (S21). For example, the CPU 710 performs the selection process by reading the radio access technology selection program 763 from the storage 760 and executing the read program.

FIG. 9 is a flowchart illustrating an example of the selection process of the radio access technology. If the selection process of the radio access technology is started (S210), the communication control device 700 calculates the WLAN utilization efficiency of the terminal 200 that uses WLAN (S211). For example, the CPU 710 calculates the WLAN utilization efficiency by reading the WLAN utilization efficiency calculation program 762 from the storage 760 and executing the read program.

FIG. 10 is a flowchart illustrating an operation example of the calculation process of the WLAN utilization efficiency. If the calculation process of the WLAN utilization efficiency is started (S2110), the communication control device 700 configures the WLAN feature information 766 (S2111).

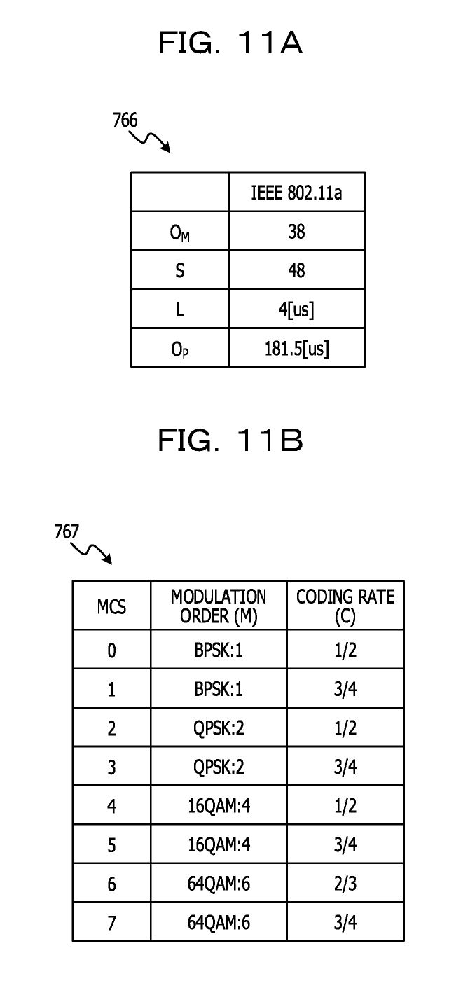

FIG. 11A is a diagram illustrating an example of the WLAN feature information 766. For example, the WLAN feature information 766 is information exhibiting the features of WLAN. As the WLAN feature information 766, there are an overhead (OM) in a media access control (MAC) layer, the number of effective subcarriers (S), a length (L) of one OFDM symbol in a time domain, and an overhead (Op) in the physical layer.

The overhead (OM) in the MAC layer represents the amount (for example, the number of bytes) of a portion other than data in one frame of the MAC layer of WLAN. In the case of IEEE 802.11a, O_{M}=38 [byte] (=MAC header (26 bytes)+logical link control (LLC) header (8 bytes)+frame check sequence (FCS) (4 bytes)).

For example, the number of effective subcarriers (S) is the number of subcarriers (or data subcarriers) used for transmitting as much data as one frame in the physical layer of WLAN. In the case of IEEE 802.11a, S=48.

For example, the length (L) of one OFDM symbol in the time domain represents one OFDM symbol time of WLAN. In the case of IEEE 802.11a, L=4 [μs].

For example, the overhead (O_{P}) in the physical layer represents the amount (for example, time) of a portion other than data in one frame in the physical layer of WLAN. In the case of IEEE 802.11a, O_{P}=181.5 [μS] (=DIFS (34 μs)+center value (67.5 μs) of random backoff+Short Interframe Space (SIFS) (16 μS)+acknowledge (ACK) (44 μS)+short preamble length (8 μs)+long preamble length (8 μs)+SIGNAL length (4 μs)).

For example, the WLAN feature information 766 is previously stored in the storage 760 as illustrated in FIG. 6, and is appropriately read when the CPU 710 executes the WLAN utilization efficiency calculation program 762.

Referring back to FIG. 10, subsequently, the communication control device 700 converts the radio quality information (MCS) received from each terminal 200 into a modulation order (M) and a coding rate (C) by referring to the radio quality conversion information 767 (S2112).

FIG. 11B is a diagram illustrating an example of the radio quality conversion information 767. For example, it is possible to uniquely determine the modulation scheme used in the modulation process and the coding rate (C) used in the error correction coding process depending on the radio quality information (MCS). It is possible to determine the modulation order (M) depending on the modulation scheme. For example, the radio quality conversion information 767 functions as a conversion table for acquiring the coding rate (C) and the modulation order (M) from the MCS.

Even in a case where the received power value or signal interface to noise ratio (SINR) is used as the radio quality, the modulation order (M) and the coding rate (C) corresponding to the received power value or the SINR may be stored in the radio quality conversion information 767. For example, the modulation order (M) and the coding rate (C) corresponding to the radio quality may be stored in the radio quality conversion information 767.

Referring back to FIG. 10, subsequently, the communication control device 700 calculates WLAN utilization efficiency (E) (S2113). A calculation method of the WLAN utilization efficiency (E) will be initially described, and a case where the WLAN utilization efficiency (E) is changed depending on the packet length of the IP layer will be described.

<Calculation Method of WLAN Utilization Efficiency>

For example, the CPU 710 calculates the WLAN utilization efficiency (E) by using the following Expression.

$$E = \frac{P \cdot 8}{⌈ \frac{( P + {O}_{M} ) \cdot 8}{C \cdot M \cdot S} ⌉ \cdot L + {O}_{P}} \qquad ( 3 )$$

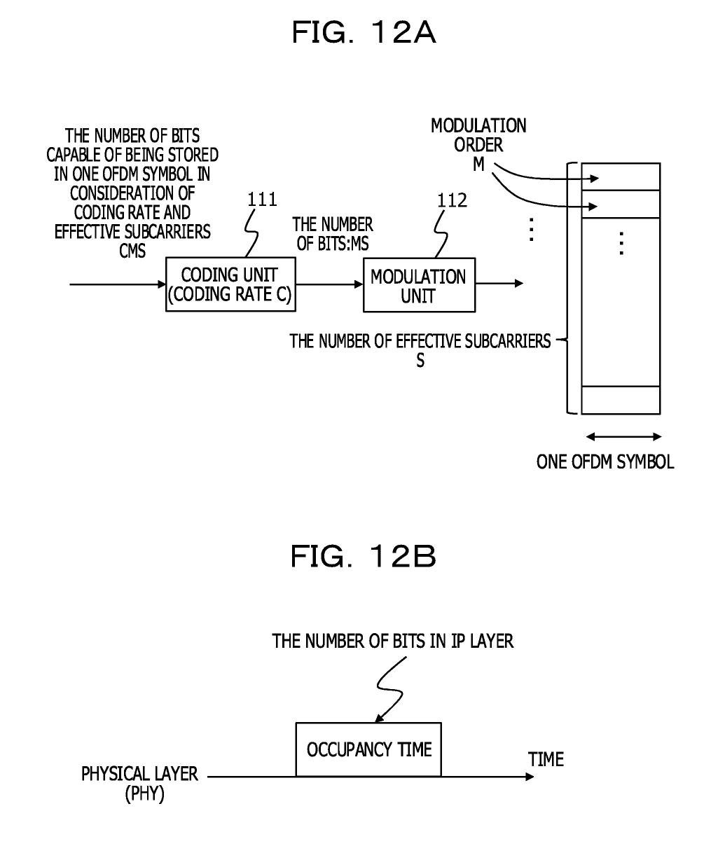

Expression (3) will be described. In Expression (3), “CMS” which is a denominator will be initially described. FIG. 12A is a diagram for describing “CMS”. For example, “CMS” represents the number of bits capable of being stored in one OFDM symbol in consideration of the coding rate (C) and the number of effective subcarriers (S). In the above-described process (S2112), the CPU 710 acquires the modulation order (M) from the radio quality information (MCS) based on the radio quality conversion information 767. The modulation order (M) simply represents the number of bits depending on the modulation scheme, for example, M=1 in a case where the modulation scheme is binary phase shift keying (BPSK), and M=2 in a case where the modulation scheme is quadrature phase shift keying (QPSK), and represents the number of bits capable of being transmitted in a case where one subcarrier within one OFDM symbol is focused on.

Thus, “MS” bits (the number of bits=M×S) per one OFDM symbol can be transmitted.

In WLAN, the error correction coding process is performed using the coding rate (C). If the coding rate is taken into consideration, the number of bits capable of being stored in one OFDM symbol in a case where the coding rate and the effective subcarriers are taken into consideration is “CMS”.

Subsequently, in Expression (3),

$$⌈ \frac{( P + {O}_{M} ) \cdot 8}{C \cdot M \cdot S} ⌉ \qquad ( 4 )$$

the number of symbols of one OFDM symbols included in a data portion of one IP packet is acquired. This is because the packet length (P) of the IP packet is divided by the number of bits CMS capable of being stored in one OFDM symbol in a case where the coding rate and the effective subcarriers are taken into consideration, and thus, the number of symbols of the OFDM symbols included in one IP packet is acquired. In Expression (4), the overhead (O_{M}) of the MAC layer is added to the packet length (P) of the IP packet, and thus, the overhead (O_{M}) in the MAC layer is taken into consideration.

If the denominator of Expression (3) is focused on by taking the aforementioned description, Expression (4) multiplies by one OFDM symbol time (L). For example, due to the multiplication, a time length in the physical layer of the data portion of one IP packet is calculated. For example, the overhead (O_{P}) of the physical layer is added to the time length, and thus, a time taken to transmit one IP packet (for example, the header portion and the data portion of one IP packet) in the physical layer is calculated. For example, in Expression (4), the overhead (O_{P}) represents a time taken to transmit the overhead portion of one IP packet in the time domain. For example, the overhead (O_{P}) may include a time of a portion other than the data such as a center value (67.5 μs) of random backoffs or DIFS (34 μs), as illustrated in FIG. 7B.

Accordingly, the denominator in Expression (3) represents, for example, an occupancy time occupied to transmit (or time taken to transmit) one IP packet (or data of one IP packet) in the physical layer of WLAN. FIG. 12B illustrates an example of the occupancy time.

In Expression (3), the average value (P) of the packet lengths of the IP layer is divided by the occupancy time. Accordingly, Expression (3) (or WLAN utilization efficiency (E)) represents, for example, the amount of data (the number of bits) capable of being transmitted in the IP layer for the occupancy time occupied to transmit one frame in the physical layer of WLAN.

<Changing of WLAN Utilization Efficiency (E) depending on Packet Length of IP Layer>

Hereinafter, the changing of the WLAN utilization efficiency (E) depending on the packet length of the IP packet will be described.

If Expression (3) is transformed,

$$E = \frac{8}{⌈ \frac{( 1 + \frac{{O}_{M}}{P} ) \cdot 8}{C \cdot M \cdot S} ⌉ \cdot L + \frac{{O}_{P}}{P}} \qquad ( 5 )$$

the above expression is acquired.

In a case where the packet length (P) of the IP packet is sufficiently great (for example, P>>0), Expression (5) can be transformed into the following expression.

$$E = \frac{8}{⌈ \frac{8}{C \cdot M \cdot S} ⌉ \cdot L} ≅ \frac{C \cdot M \cdot S}{L} \qquad ( 6 )$$

That is, in a case where the packet length (P) of the IP packet is sufficiently great, a value depending on the radio quality (MCS) is acquired as the WLAN utilization efficiency (E).

Meanwhile, in a case where the packet length (P) of the IP packet is sufficiently small (for example, P=0 or P≈0), Expression (5) can be transformed into E=0. That is, in a case where the packet length (P) of the IP packet is sufficiently small, “0” or a value approximating to “0” is acquired as the WLAN utilization efficiency (E).

As mentioned above, the value of the WLAN utilization efficiency (E) becomes great in a case where the packet length of the IP packet is sufficiently great, and the value thereof approximates to “0” in a case where the packet length is sufficiently small. Accordingly, the WLAN utilization efficiency (E) is changed depending on the packet length of the IP packet. Therefore, a case where the WLAN utilization efficiency (E) represents time utilization efficiency changed depending on the packet lengths of the packets used in the transmission or reception in the terminal 200 may be described as an example.

Referring back to FIG. 10, if the WLAN utilization efficiency (E) is calculated (S2113), the communication control device 700 ends the calculation process of the WLAN utilization efficiency (S2114). In the example of FIG. 8, since the terminals 200-1 and 200-2 use WLAN, the communication control device 700 calculates the WLAN utilization efficiencies of the terminals 200-1 and 200-2 (S211 of FIG. 9).

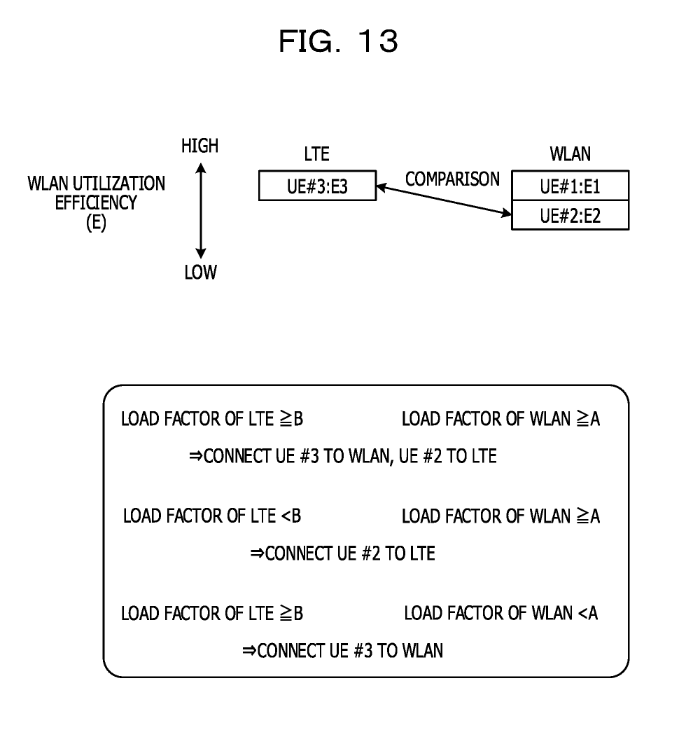

Subsequently, the communication control device 700 extracts the terminal 200 of which the WLAN utilization efficiency (E) is the worst, among the terminals 200 that use WLAN (S212). In the example of FIG. 8, the CPU 710 compares the WLAN utilization efficiency (E) of the terminal 200-1 with the WLAN utilization efficiency (E) of the terminal 200-2, and selects the terminal 200-2 of which the WLAN utilization efficiency (E) is the smallest. In this case, the CPU 710 stores the worst WLAN utilization efficiency (E) as “Utilization Efficiency A” and the terminal 200 having the worst utilization efficiency as “Terminal A” in the memory 730. FIG. 13 illustrates an example of the WLAN utilization efficiency. As illustrated in FIG. 13, since the WLAN utilization efficiency of the terminal 200-2 (UE #2) is “E 2 ” and the WLAN utilization efficiency of the terminal 200-1 (UE #1) is “El”, E 2 =Utilization Efficiency A.

Referring back to FIG. 9, subsequently, the communication control device 700 calculates the WLAN utilization efficiency (E) of the terminal 200 that uses LTE (S213). In this case, for example, the CPU 710 calculates the WLAN utilization efficiency (E) of the terminal 200-3 that uses LTE by performing the calculation process of the WLAN utilization efficiency illustrated in FIG. 10. In this case, similarly to the terminals 200-1 and 200-2 that use WLAN, the terminal 200-3 that uses LTE calculates the WLAN utilization efficiency (E) (Expression (3)) by using the WLAN feature information 766. For example, the WLAN utilization efficiency (E) in this case may be described as time utilization efficiency in a case where the terminal 200-3 that uses LTE uses WLAN.

Referring back to FIG. 9, subsequently, the communication control device 700 extracts the terminal 200 of which the WLAN utilization efficiency is the best, among the terminals 200 that use LTE (S214). In the example of FIG. 8, since only the terminal 200-3 uses LTE, the CPU 710 extracts the terminal 200-3 as the terminal 200 of which the WLAN utilization efficiency is the best. The CPU 710 stores the best WLAN utilization efficiency (E) as “Utilization Efficiency B” and the terminal 200 having the best utilization efficiency as “Terminal B” in the memory 730. As illustrated in FIG. 13, the WLAN utilization efficiency of the terminal 200-3 (UE #3) is “E3 ”, and E3=Utilization Efficiency B.

Subsequently, the communication control device 700 determines whether or not |Utilization Efficiency A-Utilization Efficiency B| is equal to or greater than a utilization efficiency threshold α (S215). In the example of FIG. 13, the CPU 710 compares “E2” with “E3”, and determines whether or not a difference thereof is equal to or greater than the utilization efficiency threshold α.

Referring back to FIG. 9, when |Utilization Efficiency A—Utilization Efficiency B| is equal to or greater than the utilization efficiency threshold α (“True” in S 215), the communication control device 700 determines whether or not the WLAN load factor is equal to or greater than a WLAN load factor threshold A and the LTE load factor is equal to or greater than an LTE load factor threshold B (S216).

When the WLAN load factor is equal to or greater than the WLAN load factor threshold A and the LTE load factor is equal to or greater than the LTE load factor threshold B (“True” in S216), the communication control device 700 changes the radio access technology of Terminal A and the radio access technology of Terminal B to “LTE” and “WLAN”, respectively (S217).

In the example of FIG. 13, when a difference between “E2” and “E3” is equal to or greater than the threshold α and the load factor of LTE and the load factor of WLAN are also equal to or greater than the thresholds A and B, the CPU 710 changes the radio access technology of the terminal 200-3 (UE #3) from “LTE” to “WLAN”. The CPU 710 changes the radio access technology of the terminal 200-2 (UE #2) from “WLAN” to “LTE”.

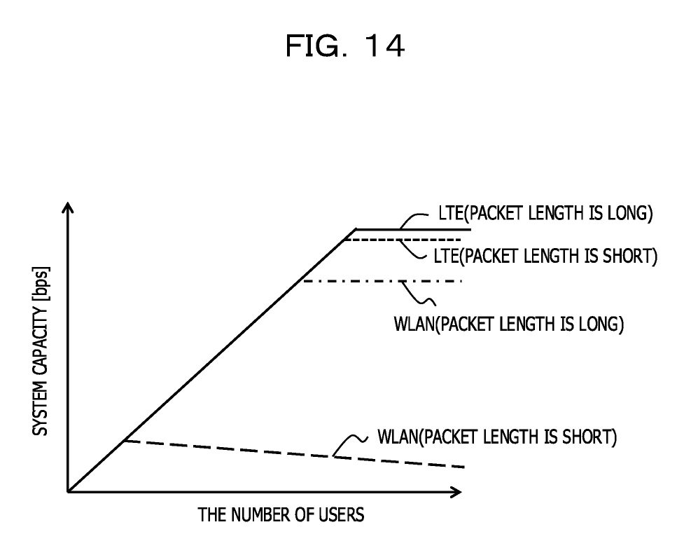

As described above, the time utilization efficiency depending on a packet length in WLAN is further changed than that in LTE. FIG. 14 is a graph illustrating an example of the time efficiencies (system capacity in FIG. 14) of WLAN and LTE.

In FIG. 14, a vertical axis represents the system capacity, and a horizontal axis represents the number of connected users (or the number of connected terminals). In this drawings, “LTE (packet length is long)” represents the terminal that uses the packets of which the packet length is greater than the packet length threshold, among the terminals 200 that use LTE. “WLAN (packet length is short)” represents the terminal that uses the packets of which the packet length is equal or less than the packet length threshold among the terminals 200 that use WLAN.

As illustrated in FIG. 14, the magnitude of the packet length in the case of LTE is not further changed by the time efficiency than that in the case of WLAN. Meanwhile, the magnitude of the packet length in the case of WLAN is further changed by the time efficiency than that in the case of LTE. Particularly, in a case where the packet length is less than the threshold, the time efficiency in WLAN is further decreased than that in the case of LTE.

In the example of FIG. 13, the terminal 200-2 (UE #2) has the lowest time efficiency than that of another terminal that uses WLAN. In the example of FIG. 14, the terminal 200-2 is likely to correspond to “WLAN (packet length is short)”.

In such a case, the communication control device 700 causes the terminal 200-2 having the worst WLAN utilization efficiency to use LTE by changing the radio access technology of the terminal 200-2 from WLAN to LTE, and can improve the time utilization efficiency of the terminal 200-2.

For example, due to such a change, the number of terminals corresponding to “WLAN (packet length is short)” is reduced, among the terminals that use WLAN. Accordingly, the load of the WLAN access point 500 is reduced, and thus, it can also be expected that the time efficiency of WLAN is improved.

Meanwhile, in the example of FIG. 13, the terminal 200-3 (UE #3) has the highest WLAN utilization efficiency, among the terminals 200 that use LTE. The load factor of LTE becomes equal or greater than the LTE load factor threshold B. In such a case, the communication control device 700 changes the radio access technology of the terminal 200-3 from LTE to WLAN. Accordingly, for example, the utilization efficiency of the terminal 200-3 itself is not further decreased than that in a case where the terminal 200-2 uses WLAN. In the WLAN access point 500, the utilization efficiency in the case of the wireless communication with the terminal 200-3 is further improved than that in the case of the wireless communication with the terminal 200-2. The load of the base station 100 that uses LTE can be reduced.

As stated above, the communication control device 700 respectively changes the radio access technology of the terminal 200-2 from WLAN to LTE and the radio access technology of the terminal 200-3 from LTE to WLAN, and thus, it is possible to improve the utilization efficiency of WLAN in which the time utilization efficiency is changed depending on the packet length so as to be equal to or greater than the threshold.

It is possible to reduce the loads of the WLAN access point 500 and the base station 100, and thus, it is possible to reduce the load of the entire wireless communication system 10.

Referring back to FIG. 9, the communication control device 700 notifies the terminal 200 of the changed radio access technology (S218). For example, the communication control device 700 respectively notifies the terminal 200-2 and the terminal 200-3 of “LTE” and “WLAN”.

The communication control device 700 ends the performing of the radio access technology selection program 763, and ends the selection process of the radio access technology (S219).

Meanwhile, when the WLAN load factor is equal to or greater than the WLAN load factor threshold A and the LTE load factor is not equal to or greater than the LTE load factor threshold B (“False in S216), the communication control device 700 determines whether or not the WLAN load factor is equal or greater than the WLAN load factor threshold A (S220). When the WLAN load factor is equal or greater than the WLAN load factor threshold A (“True” in S220), the communication control device 700 changes the radio access technology of Terminal A to “LTE” (S221).

In the example of FIG. 13, when the WLAN load factor is not equal or greater than the threshold A and the LTE load factor is not equal or greater than the threshold B, and the WLAN load factor becomes equal to or greater than the WLAN load factor threshold A, the CPU 710 changes the radio access technology of the terminal 200-2 (UE #2) to “LTE”.

The CPU causes the terminal 200-2 (UE #2) having the bad utilization efficiency among the terminals that use WLAN to use “LTE”, and thus, it is possible to further improve the time utilization efficiency of the terminal 200-2 itself that that in a case where WLAN is used. Since the number of terminals that use WLAN is reduced, the WLAN load factor is also reduced, and thus, it is possible to reduce the load of the WLAN access point 500. Accordingly, it is possible to improve the utilization efficiency of WLAN of which the time utilization efficiency is changed depending on the packet length so as to be equal or greater than the threshold.

Referring back to FIG. 9, the communication control device 700 notifies the terminal 200 of the changed radio access technology (S218), and ends a series of selection processes (S219). In the above-described example, the communication control device 700 notifies the terminal 200-2 of “LTE”.

Meanwhile, when the WLAN load factor is not equal or greater than the WLAN load factor threshold A (“False” in S 220), the communication control device 700 determines whether or not the LTE load factor is equal or greater than the LTE load factor threshold B (S222). When the LTE load factor is equal or greater than the LTE load factor threshold B (“True” in S 222), the communication control device 700 changes the radio access technology of Terminal B to “WLAN” (S223).

In the example of FIG. 13, when the WLAN load factor is not equal or greater than the threshold A and the LTE load factor is not equal or greater than the threshold B, and the LTE load factor becomes equal or greater than the threshold B, the CPU 710 changes the radio access technology of the terminal 200-3 (UE #3) having the best WLAN utilization efficiency to “WLAN”. In this case, for example, even though the terminal 200-3 (UE #3) having the good WLAN utilization efficiency is connected to WLAN, the time utilization efficiency of the terminal 200-3 itself is not further decreased than that of the terminal 200-2. Since the number of terminals connected to LTE is reduced, the LTE load factor is also reduced, and thus, it is possible to reduce the load of the base station 100.

Meanwhile, referring back to FIG. 9, when |Utilization Efficiency A—Utilization Efficiency B| is not equal or greater than the utilization efficiency threshold α (when |Utilization Efficiency A—Utilization Efficiency B| is less than the utilization efficiency threshold α) (“False” in S215), the communication control device 700 ends a series of processes without changing the radio access technology (S219). For example, the reason why the radio access technology is not changed is because it is expected that the utilization efficiency of WLAN is not further improved than that in a case where the difference therebetween is equal or greater than the utilization efficiency threshold a even though the radio access technology of the terminal 200 is changed.

For example, if FIG. 13 is focused on in a case where the radio access technology is changed, when the difference between the WLAN utilization efficiencies of the terminal 200-3 and the terminal 200-2 is equal or greater than the utilization efficiency threshold a and the WLAN load factor is equal or greater than the WLAN load factor A, the radio access technology of the terminal 200-2 is changed from WLAN to LTE. Meanwhile, the same is true of the terminal 200-3 and when the difference between the WLAN utilization efficiencies of the terminal 200-3 and the terminal 200-2 is equal or greater than the utilization efficiency threshold α and the LTE load factor is equal or greater than the LTE load factor threshold B, the radio access technology of the terminal 200-3 is changed from LTE to WLAN.

Referring back to FIG. 8, if the selection process (S21) of the radio access technology is ended, the communication control device 700 transmits the selection result to the terminal 200 (S24, and S 218 of FIG. 9). As mentioned above, the communication control device 700 transmits the changed (or selected) radio access technologies to the terminals 200-2 and 200-3.

The communication control device 700 ends a series of processes.

### Third Embodiment

Hereinafter, a third embodiment will be described. It has been described in the second embodiment that the communication control device 700 measures the packet lengths. It will be described in the third embodiment that the respective terminals 200 measure the packet lengths.

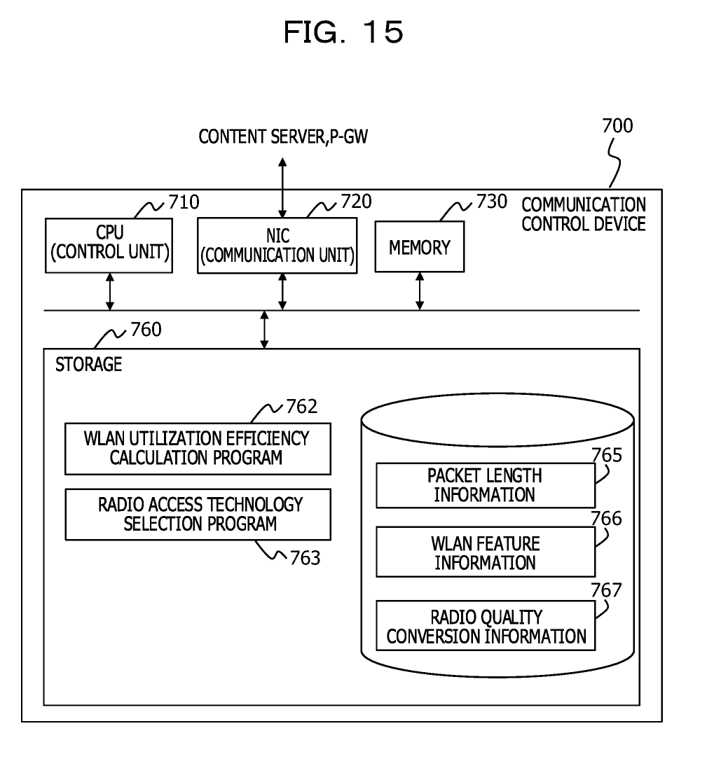

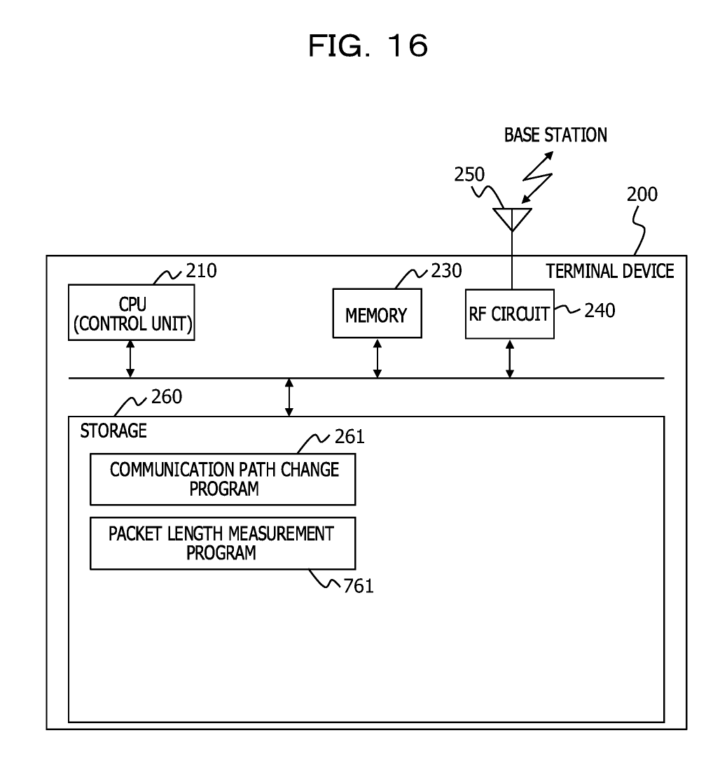

FIG. 15 is a diagram illustrating a structure example of the communication control device 700 according to the third embodiment, and FIG. 16 is a diagram illustrating a structure example of the terminal 200 according to the third embodiment. As illustrated in FIGS. 15 and 16, the packet length measurement program 761 is stored not in the communication control device 700 but in the terminal 200. The CPU 210 of the terminal 200 performs the measurement process of the packet length by reading the packet length measurement program 761 stored in the storage 260 and executing the program 761. Similarly to the second embodiment, the CPU 210 measures, as the packet length, the average value or the center value of the packet lengths of the individual IP packets within the measurement time. The CPU 210 transmits the measured packet lengths (P) of the IP packets to the communication control device 700 via the base station 100 or the WLAN access point 500.

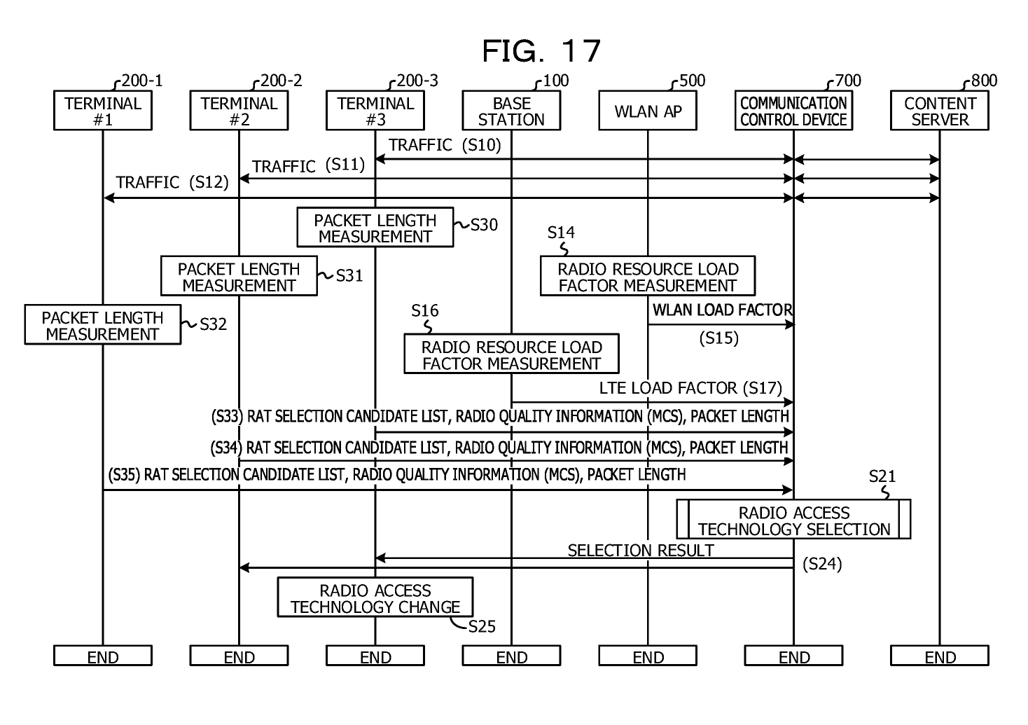

FIG. 17 is a diagram illustrating a sequence example according to the third embodiment. The respective terminals 200-1 to 200-3 measure the packet lengths (P) (S30 to S32), and transmit the measured packet lengths to the communication control device 700 (S33 to S35). The respective terminals 200-1 to 200-3 may transmit the measured packet lengths together with the radio quality information (MCS) or the selection candidate list of the radio access technologies. Thereafter, similarly to the second embodiment, the communication control device 700 performs the selection process (for example, FIG. 9) of the radio access technology and the calculation process (for example, FIG. 10) of the WLAN utilization efficiency based on the packet length or the radio quality information (MCS).

### Another Embodiment

It has been described in the above-described second and third embodiments that the CPUs 110, 210, 310, 410, 510, 610, and 710 are used in the respective devices 100, 200, 300, 400, 500, 600, and 700. For example, as long as the CPU can be realized as the control unit or the controller, a micro processing unit (MPU), a digital signal processor (DSP), or a field programmable gate array (FPGA) may be used instead of the CPU.

It has been described in the second and third embodiments that WLAN of IEEE 802.11 series is used as the example of the radio access technology in which the time utilization efficiency is greatly changed depending on the packet length. A radio access technology other than WLAN may be used. It has been described that LTE is used as the example of the radio access technology in which the time utilization efficiency is not further changed depending on the packet length than that in the case of WLAN. For example, a radio access technology such as LTE-Advanced, 3G, or 5G may be used as such a radio access technology.

It has been described that the memories 130, 230, 330, 430, 530, 630, and 730 and the storages 160, 260, 360, 460, 560, 660, and 760 are respectively provided as separate blocks within the respective devices. For example, the memories 130, 230, 330, 430, 530, 630, and 730 and the storages 160, 260, 360, 460, 560, 660, and 760 may be respectively provided as one block (for example, memories) within the respective devices.

For example, it has been described in the second and third embodiments that the packet of the IP layer which is the higher layer than the physical layer is used in the WLAN utilization efficiency. For example, the packets of the higher layer than the physical layer, that is, the packets of the MAC layer may be used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control device comprising:
a memory; and
a processor coupled to the memory and the processor configured to:
select a radio access technology among from a first radio access technology and second radio access technology based on utilization efficiency, a first load factor and a second load factor, the utilization efficiency depending on a packet length of a packet used in communication between a terminal device and a first wireless communication device by using a first radio access technology or between the terminal device and a second wireless communication device by using a second radio access technology, the terminal device being capable of communicating with both the first wireless communication device and the second wireless communication device, the first load factor indicating a load of radio resources corresponding to the first radio access technology, the second load factor indicating a load of radio resources corresponding to the second radio access technology; and
cause the terminal device to execute communication by using the selected radio access technology.

2. The communication control device according to claim 1,
wherein, the processor is configured to:
select, in the selecting, the second radio access technology for a first terminal device when a difference between first utilization efficiency of the first terminal device and second utilization efficiency of a second terminal device is equal to or greater than a first threshold, both the first terminal device and the second terminal device including in a plurality of terminal devices, the first utilization efficiency being utilization efficiency of communication using the first radio access technology, the second utilization efficiency being utilization efficiency of communication using the second radio access technology, the first terminal device being a terminal device whose first utilization efficiency is lowest among the plurality of terminal devices, the terminal device being a terminal device whose first utilization efficiency is lowest among the plurality of terminal devices, second terminal device a terminal device whose second utilization efficiency is highest among the plurality of terminal devices.

3. The communication control device according to claim 2,
wherein, the processor is configured to:
select, in the selecting, the first radio access technology for the second terminal device when the second load factor is equal or greater than a third threshold.

4. The communication control device according to claim 2,
wherein, the processor is configured to:
select, in the selecting, the first radio access technology for the second terminal device when the first load factor is less than a second threshold and when the second load factor is equal or greater than a third threshold.

5. The communication control device according to claim 2,
wherein, the processor is configured to:
cause each of the first terminal device and the second terminal device to keep on executing communication using a radio access technology currently used when the first load factor is less than a second threshold and when the second load factor is less than a third threshold.

6. The communication control device according to claim 2,
wherein, the processor is configured to:
cause each of the first terminal device and the second terminal device to keep on executing communication using a radio access technology currently used when when the difference between first utilization efficiency of the first terminal device and second utilization efficiency of the second terminal device is less than the first threshold.

7. The communication control device according to claim 1,
wherein the utilization efficiency represents the number of bits capable of being transmitted in an Internet protocol (IP) layer for an occupancy time occupied for transmitting one frame in a physical layer.

8. The communication control device according to claim 1,
wherein the utilization efficiency represents time utilization efficiency changed depending on the packet length of the packet.

9. The communication control device according to claim 7,
wherein the occupancy time represents a time taken to transmit one packet of the IP layer in the physical layer.

10. The communication control device according to claim 7,
wherein the occupancy time represents a time for the first terminal device or the second wireless communication device to transmit one packet of the IP layer and to receive a response signal to the one packet after carrier sensing is started.

11. The communication control device according to claim 1,
wherein, the processor is configured to:
obtain, as the utilization efficiency, a first value obtain by dividing the amount of data included in one packet of the IP layer by occupancy time, the occupancy time being obtained by adding a time of an overhead other than data in a physical layer to a second value, the second value being obtained by multiplying a length of one OFDM symbol in a time domain by the number of symbols of orthogonal frequency-division multiplexing (OFDM) symbols used when the data included in the one packet of the IP layer is transmitted.

12. The communication control device according to claim 11,
wherein, the processor is configured to:
obtain the number of symbols of OFDM symbols based on radio quality information in a radio communication between the terminal device and the first wireless communication device or between the terminal device and the second wireless communication device.

13. The communication control device according to claim 1, further comprising:
wherein the memory stores information indicating following Expression 7 (where, C is a coding rate, M is a modulation order, S is the number of effective subcarriers, P is a packet length of one IP packet, O_{M} is an overhead of a media access control (MAC) layer, and O_{P} is an overhead of a physical layer); and
$$\frac{P \cdot 8}{⌈ \frac{( P + {O}_{M} ) \cdot 8}{C \cdot M \cdot S} ⌉ \cdot L + {O}_{P}} \qquad ( 7 )$$
wherein, the processor is configured to:
obtain the utilization efficiency based on radio quality information in a radio communication between the terminal device and the first wireless communication device or between the terminal device and the second wireless communication device and the information indicating the Expression 7 read from the memory.

14. A communication control method executed by a computer, the communication control method comprising:
selecting a radio access technology among from a first radio access technology and second radio access technology based on utilization efficiency, a first load factor and a second load factor, the utilization efficiency depending on a packet length of a packet used in communication between a terminal device and a first wireless communication device by using a first radio access technology or between the terminal device and a second wireless communication device by using a second radio access technology, the terminal device being capable of communicating with both the first wireless communication device and the second wireless communication device, the first load factor indicating a load of radio resources corresponding to the first radio access technology, the second load factor indicating a load of radio resources corresponding to the second radio access technology; and
causing the terminal device to execute communication by using the selected radio access technology.

15. A non-transitory computer-readable storage medium storing a communication control program that causes a computer to execute a process, the process comprising:
selecting a radio access technology among from a first radio access technology and second radio access technology based on utilization efficiency, a first load factor and a second load factor, the utilization efficiency depending on a packet length of a packet used in communication between a terminal device and a first wireless communication device by using a first radio access technology or between the terminal device and a second wireless communication device by using a second radio access technology, the terminal device being capable of communicating with both the first wireless communication device and the second wireless communication device, the first load factor indicating a load of radio resources corresponding to the first radio access technology, the second load factor indicating a load of radio resources corresponding to the second radio access technology; and
causing the terminal device to execute communication by using the selected radio access technology.
